(19) United States
(12) Patent Application Publication
(10) Pub. No.: US 2014/0365886 A1
(43) Pub. Date: Dec. 11, 2014

(54) Using Scrollbars as Live Notification Areas

(71) Applicant: Microsoft Corporation, Redmond, WA (US)

(72) Inventors: Kimberly Koenig, Redmond, WA (US); Ruth Kikin-Gil, Bellevue, WA (US); Kathryn V.J. Sullivan, Redmond, WA (US); Peter Frem, Redmond, WA (US)

(21) Appl. No.: 13/910,322

(22) Filed: Jun. 5, 2013

(51) Int. Cl. G06F 3/0485

(52) U.S. Cl. CPC G06F 3/04855
USPC 715/711; 715/787

(57) ABSTRACT

A vertical or horizontal scrollbar or scrollbar-like navigation component may be used as both a navigation tool and as a live notification area in which a variety of valuable, interesting or other information may be presented. Marks or other icons and/or indicators may be provided in the scrollbars for conveying information and notifications to a user. Cross-document navigation may be provided through a horizontal or vertical pane for allowing a user to see and navigate graphical representations (e.g., text and/or thumbnails) of a variety of documents or other content items, wherein the graphical representations may include summary text or icons for providing a variety of information to the user about associated represented documents and other content items.

### BACKGROUND

With the advent of computer software, a variety of user interfaces (UI) have been developed for allowing users to interact with software functionality and a variety of documents and other content. A number of UI interaction models have been used including models for allowing users to surface and navigate to interesting content items, notifying users when something is changed in a document, and allowing navigation to a document linearly using vertical or horizontal scrollbars. However, such systems typically make it difficult for a user to see interesting items that are located relative to each other and within a document as a whole. For example, when comments have been added to a document, current user interface interaction models do not allow a user to readily determine who added comments to a document, which comments are new relative to other comments, which pages in a document have comments, where comments are located relative to each other, and how many comments there are on a given page of a document. Thus, there is no way for a user to navigate directly to a particular comment with a single click or other user interaction. Instead, users must scroll until they find a desired comment, or use a next/previous button in a review section of a user interface to iterate through comments one at a time. Similarly, there is often a separate navigation pane for navigating through sections and/or chapters of a document. In general, having separate experiences for locating important places in a document and overall document navigation is inefficient and confusing.

Some software applications may allow for highlighting in a scrollbar to convey information, for example, by placing highlighted marks on a scrollbar to indicate where on a page a search term is found. Other systems may allow a mark or other indication for recognizing when a user has created a “to-do” item, followed by a highlighting of a location in a scrollbar associated with the “to-do” indication. However, such systems are limited because they provide information only about one or two points of interest in a document or other content item, they restrict themselves to vertical scrollbars, and they do not provide rich information, such as a “peek” at the area of interest, at-a-glance summaries, or live information in a collaboration/authoring scenario. In addition, such systems are not easily navigable for quickly navigating to an area in a document at which an interesting item is located. Moreover, such systems are not touch-optimized and are typically limited to a relatively small set of software and development tools.

It is with respect to these and other considerations that embodiments of the present invention have been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing use of scrollbars as live notification areas. A vertical or horizontal scrollbar or scrollbar-like navigation component may be used as both a navigation tool and as a live notification area in which a variety of valuable, interesting or other information may be presented. According to one embodiment, in-document navigation may be provided wherein a horizontal scrollbar, vertical scrollbar, or scrollbar-like user interface component may allow users to quickly navigate through a document by tapping/clicking on a particular location in the scrollbar or scrollbar-like component (hereafter collectively “scrollbar”) or by dragging the scroll box/button in the scrollbar to a particular location. Marks or other icons and/or indicators may be provided on the scrollbar for conveying information and notifications to a user. Information and/or notification types that may be indicated on a scrollbar may include user-created items, document structure information, live collaboration statistics, all-up summary information, as well as tool tips for providing alerts and peeks or previews of interest to a navigating user. According to another embodiment, cross-document navigation is provided wherein a horizontal or vertical pane (with scroll bar like navigation movement) may be provided for allowing a user to see and navigate graphical representations (e.g., text and/or thumbnails) a variety of documents or other content items, wherein the graphical representations may include summary text or icons for providing a variety of information to the user about associated represented documents and other content items.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention.

FIG. 1 illustrates a system architecture for enabling use of scrollbars as live notification areas.

FIG. 2 illustrates a tablet-style computing device showing an application user interface and an example vertical scrollbar in which live notification information may be provided.

FIG. 3 illustrates a computing device on which is displayed a user interface having a horizontal scrollbar showing a notification mark associated with a position in an associated document.

FIG. 4 illustrates a user touch selection of the live notification mark illustrated in FIG. 3.

FIG. 5 illustrates an automatic navigation to a position in a document associated with a live notification mark.

FIG. 6 illustrates a displayed user interface having a horizontal scrollbar and showing a variety of live notification marks indicating a variety of information types associated with various locations in a given document.

FIG. 7 illustrates a displayed user interface having a horizontal scrollbar and showing use of a “breadcrumb” notification mark for indicating historical navigation.

FIG. 8 illustrates the displayed user interface of FIG. 7 showing navigation to an immediate past navigation point in a document by navigating to a “breadcrumb” notification mark displayed in the horizontal scrollbar.

FIG. 9 illustrates a displayed user interface having a vertical scrollbar showing a variety of live notification icons and showing a tool tip component for providing information to a user about one or more content items contained in a displayed document.

FIG. 10 illustrates a displayed user interface showing a horizontal user interface component for illustrating graphical representations of a variety of documents/content items and showing live notification information associated with one or more of the variety of documents/content items.

FIG. 11 is a flowchart illustrating a method for enabling use of scrollbars as navigation tools and as live notification areas.

FIG. 12 is a block diagram illustrating an example of physical components of a computing device with which embodiments of the invention may be practiced.

FIGS. 13A and 13B are simplified block diagrams of a mobile computing device with which embodiments of the present invention may be practiced.

FIG. 14 is a simplified block diagram of a distributed computing system in which embodiments of the present invention may be practiced.

### DETAILED DESCRIPTION

As briefly described above, embodiments of the present invention are directed to using scrollbars and scrollbar-like user interface components as navigation tools and as live notification areas with which in-document navigation and cross-document navigation may be accomplished and in which may be presented one or more marks, icons, or information previews for providing useful information about various aspects of one or more documents or other content items. The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described may be modified by substituting, reordering, or adding stages to the disclosed methods. Accordingly, the following detailed description does not limit the invention but, instead, the proper scope of the invention is defined by the appended claims.

As described above, embodiments of the present invention provide for use of scrollbars (vertical and horizontal) and scrollbar-like user interface components for providing useful navigation inside a given document or content item and between a plurality of documents or content items, and for providing live notification to a navigating user of information associated with various positions or locations within a given document or content item or across one or more of a plurality of documents or content items. According to embodiments, navigation may be linear (e.g., scrolling right/left and up/down), or navigation may be nonlinear where selection of a given point on a scrollbar (e.g., touching a touch-optimized scrollbar, clicking a scrollbar, etc.) causes an automatic navigation to the corresponding point in a document or other content item. Such linear and nonlinear navigation is described in further detail below. Navigation components, such as horizontal or vertical scrollbars, scrollbar-like components, or navigable horizontal or vertical arrays of document or other content item representations may be used both as in-document and cross-document navigation tools and as live notification areas in which a variety of valuable information may be presented.

According to embodiments, in-document navigation and notification may be provided via one or more marks and/or icons of various shapes and colors which may be displayed on a scrollbar (vertical or horizontal) or scrollbar-like user interface component (hereafter “scrollbar”) for conveying such information as presence of user-created items in or associated with a document or other content item. For example, a mark and/or icon may be displayed on a variety of different scrollbar types, as described above, for indicating a location in a document or other content item of a bookmark, a flag, a personal “to-do” or task item, one or more user-created comments, footnotes, ideas including collaborative brainstorming commentaries, research items, editing timeline information, research information, edits, formatting information, and the like. As should be appreciated, these are but examples of a great number of attributes, properties, changes, structures, and the like that may be applied to a given content item, for example, a document, for which a mark and/or icon or other information providing user interface element may be placed on a scrollbar for indicating to a user the location of the user-created item in the associated content item.

The marks and/or icons presented on or in association with different types of scrollbars may also provide information about the structure of a document or other content item. For example, one or more marks and/or icons may be presented on a variety of scrollbar types for providing locations of individual pages, sections, or chapters, including identifications of chapters and/or sections such as names and titles or other identifying information. Other document structure that may be indicated by marks or icons presented in a scrollbar include locations and information associated with document headings, tables of contents, bibliographies, or other sections of a document or content item. In addition, marks and/or icons may be presented in a scrollbar for indicating the locations of found search items, placeholder locations, last page visited, and the like.

In addition, marks and/or icons or other user interface components presented in various types of scrollbars may provide locations in a document or other content item and information for live collaboration associated with a document or content item. For example, marks and/or icons may be presented in a scrollbar for providing information on the identities and presence for those persons collaborating on (creating, editing, otherwise utilizing) a given document or content item. For example, information may be provided in the scrollbar to show the identities of users who have joined a document at a given location, for example, information showing those users who are reviewing and/or editing a given page in a document or other content item. Information may be provided for showing the identities and locations of users associated with changes in a document or other content item, information may be provided for identifying users who have added comments, tasks, “to-do” items in association with a particular location of a document or content item; information may be provided for showing whether one or more collaborating users are currently engaged in a chatting session in association with a given location of a given document or content item; and information may also be provided for indicating whether one or more users have shared content, for example, a page of a given document or content item with other users. A variety of other collaboration information, for example, a number of page views that are presently being presented for a given page or other location of a given document or content item may also be presented.

In addition to the foregoing, marks and/or icons may be presented on or in association with a scrollbar for providing all-up summary information, for example, a number of comments, bookmarks, flags, “to-dos,” tasks, and the like that may be associated with or included in a given page or other section of a document or content item. Summary information may also be provided regarding a number of users collaborating on a given page or location of a document or content item. Information may be provided for summarizing a number of changes, a number of spelling and/or grammar notifications, a number of formatting variations, and the like associated with a given location, page, section, or other component of a document or content item.

In addition to the various scrollbar notification types, described above, additional information may be provided on or in association with a scrollbar via a tool tip, bubble, or other information providing user interface component that may be displayed in association with a scrollbar for providing information associated with a given location in a document or content item. For example, a tool tip may be presented upon hover-over or other focus associated with a mark or icon presented in a scrollbar, and information such as alerts and previews may be provided in the presented tool tip.

In addition to the in-document navigation and notification, described above, cross-document navigation may also be provided. For example, a horizontal or vertical navigable user interface component (scrollbar-like component) may include a graphical representation (e.g., text component, thumbnail, or combination) for each of one or more documents or other content items available to a user from a given repository of documents or content items. For example, a thumbnail representation may be provided for each document contained in a given folder of user documents for allowing a user to navigate through the various represented documents for selecting a given document for display in an application user interface for reviewing, editing, or otherwise utilizing the selected document. According to embodiments, live notification marks or icons may be presented in association with each graphical representation of each document or content item for providing a user a quick and efficient notification of information that may be associated with each document being presented in the scrollbar-like user interface component that may be of interest to the user.

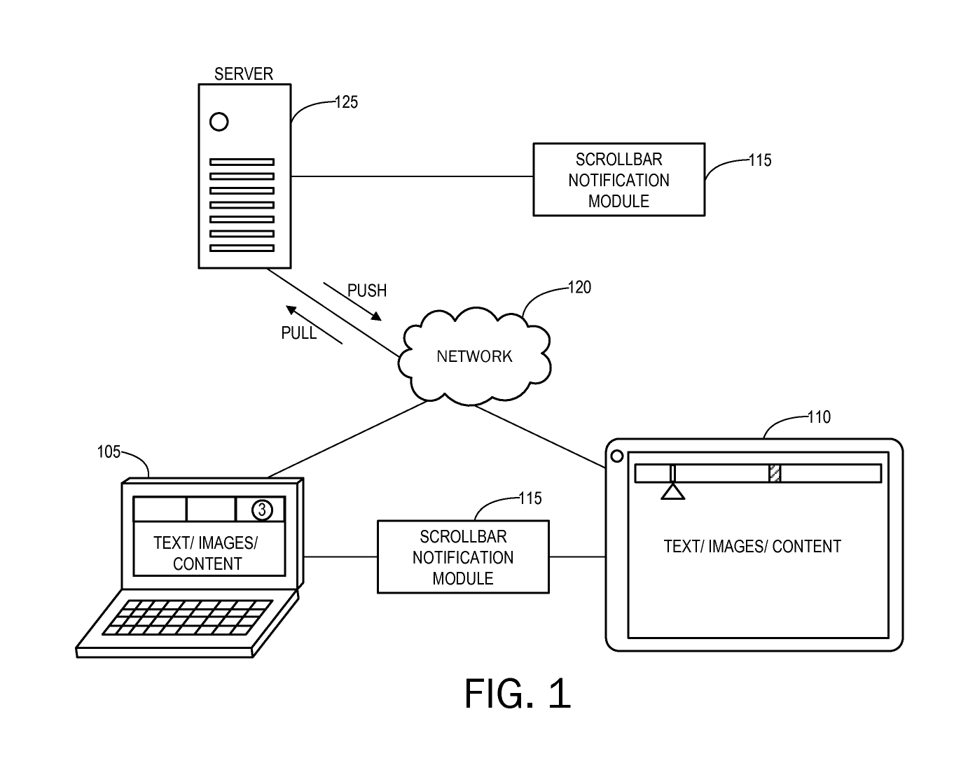

FIG. 1 illustrates a system architecture for enabling use of scrollbars as live notification areas. Computing devices 105, 110 are illustrated in FIG. 1 on which may be displayed a variety of user interfaces associated with a variety of software applications, for example, word processing applications, spreadsheet applications, slide presentation applications, electronic mail applications, calendaring applications, and the like with which one or more vertical or horizontal scrollbars may be provided for allowing a user to navigate horizontally and vertically through the content of a given document or other content item. As should be appreciated, the computing devices 105, 110 are illustrative of any suitable computing device, for example, a hand held or mobile computing device, a smartphone, a laptop computer, a desk top computer, a tablet-style computer, a slate-style computer, and the like. Furthermore, any of such computing devices 105, 110 are illustrative of devices with which input may be provided via touch, gesture, keyboard entry, mouse entry, voice command, or any other suitable input means.

According to embodiments, a scrollbar notification module 115 is illustrative of a software application having sufficient computer executable instructions for providing use of scrollbars and scrollbar-like user interface components as live notification areas, as described herein. According to one embodiment, the scrollbar notification module 115 may reside as a client application on a given computing device 105, 110 as a freestanding application that may be called on by one or more other software applications for providing scrollbar live notification, as described herein. Alternatively, the scrollbar notification module 115 may be a software module of each of a number of software applications for providing use of scrollbars as live notification areas in association with the functionality of each individual software application, for example, a word processing application.

Referring still to FIG. 1, according to another embodiment, the scrollbar notification module 115 may be associated with a remote computing/software/memory storage system (e.g., server) 125 accessible by a computing device 105, 110 via a distributed computing network 120, such as the Internet or an intranet. For example, in the case of a collaborative working environment, where users of software applications operating from different computing devices 105, 110 are collaborating on one or more documents or other content items, the documents and/or content items may be stored at a remote server 125, wherein each user accesses the content items from their respective computing devices 105, 110 via a distributed computing network 120. In such a case, the scrollbar notification module 115 may reside at a remote or “cloud-based” system 125, and use of scrollbars or scrollbar-like components as live notification areas at each of the computing devices 105, 110 may be enabled by a scrollbar notification module 115 operating in association with one or more software applications residing at the remote server or system 125. In such cases, live notifications, for example, a mark or other icon presented in a scrollbar for indicating a comment has been added to a given document may be pushed to instances of the document presented and/or displayed on the computing devices 105, 110 from the remote system/server 125 in association with the scrollbar notification module 115. Alternatively, the information may be pulled from the remote system/server 125 by scrollbar notification modules 115 residing and operating as client-side modules, as described above.

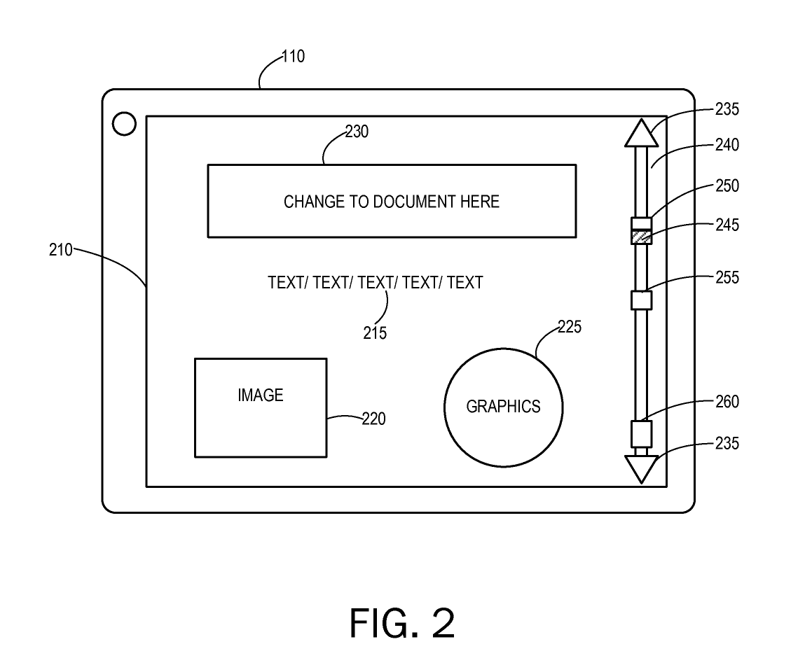

FIG. 2 illustrates a tablet-style computing device showing an application user interface and an example vertical scrollbar in which live notification information may be provided. A document 210 is illustrated displayed on a display surface of the computing device 110 in association with a user interface of one of a variety of software applications, for example, a word processing application, a slide presentation application, a spreadsheet application, and the like. The document 210 includes a variety of text components 215, images 220, graphics components 225, and the like that are typical of one or more documents or other content items that may be displayed for review, editing or other utilization by one or more users. Along the right side of the document 210 is illustrated a scrollbar 240 having a pair of directional selectable controls 235 and a slidable scroll box or scroll button 245. As well known to those skilled in the art, a scrollbar 240 may be used for navigating vertically through content contained in the document 210 by movement of the scroll box or scroll button 245 up or down along the scrollbar 240 or by selection of the controls 235 for navigating vertically through the content of the document 210.

According to embodiments of the present invention, one or more marks 250, 255, 260 may be presented in the scrollbar 240 for providing a variety of information, as described above, associated with the document 210 and for illustrating the relative positions in the document 210 of associated information. As illustrated in FIG. 2, each of the marks 250, 255, 260 is illustrated as a highlighting mark for indicating that some type of information is associated with the document 210 at positions in the document 210 relative to the locations of the marks 250, 255, 260 in association with the present location of the scroll box or scroll button 245. For example, the mark 250 is illustrative of a location in the document 210 where a current change 230 to the document 210 has been made by one or more users. For example, the present user, or another user may have edited a paragraph of the document 210 during a previous or present editing session. Once the user commences or finishes making the change 230 to the document 210, a mark or icon 250 may be dynamically (live) displayed or presented in the scrollbar 240 at a position in the scrollbar 240 relative to the position of the change made to the document 210. Similarly, the marks 255 and 260 may indicate locations in the document where other changes have been made to the document 210 such that moving the scroll box or scroll button 245 in the direction of the presented marks 255, 260 will allow navigation of the document 210 toward the locations of the corresponding document changes as desired by the navigating user. As should be understood, the marks 250, 255, 260 may represent locations of (and provide information for) any other type of notification information described above in addition to the example document changes.

As described herein, the marks and/or icons 250, 255, 260 may provide a variety of useful information in addition to the relative positions in a document or other content item associated with the marks and/or icons. According to embodiments, one or more display characteristics of the marks or icons may be provided and may be varied for conveying information contained in or about corresponding locations in the electronic document or content item. For example, as illustrated in FIG. 2, each of the marks 250, 255, 260 are illustrated as having varying sizes. For example, the mark 250 is smaller than the mark 255 which is, in turn, smaller than the mark 260. According to an embodiment, the display sizes of the marks 250, 255, 260 may be used as an indication of a quantity or value associated with the notification. For example, the fact that the mark 260 is displayed as significantly larger than the mark 250 may indicate that changes made to or other properties applied to the document and indicated by the mark 260 are longer, more voluminous or more extensive than changes made to or properties applied to the document as indicated by the mark 250. Thus, a reviewing user will gather important information, for example, the extensiveness of changes made to various pages or other sections of a document by simply noticing the size of one mark 250 compared to the size of a different mark 260.

As will be described below, a number of other presentation attributes may be applied to marks and/or icons 250, 255, 260 to convey information to the user. For example, a text item may be displayed on each mark to indicate a numerical value associated with the indicated notification. For example, a number “3” may be displayed over the mark 250, and a number “8” may be displayed over the mark 260. If the marks 250, 255, 260 are being utilized to indicate numbers of comments made to a document or content item at locations in the document or content item relative to the marks 250, 255, 260, then text components such as numbers may be utilized for indicating the number of comments that may be provided in the document or content item at the respective locations. According to other embodiments, different color schemes may be applied to different marks and/or icons 250, 255, 260 for indicating different types of notifications. For example, a blue mark or icon may indicate the presence of a bookmark, a red mark or icon may indicate the presence of a flag, a yellow mark or icon may indicate the presence of a comment, a green mark or icon may indicate the presence of a footnote, a black mark or icon may indicate the location of a research item, and the like.

As should be appreciated, these are but examples of the numerous ways in which a mark or icon 250, 255, 260 may be displayed on or in association with a scrollbar or scrollbar-like user interface component 240 for notifying a user of a type of information available to the user at a given location in a document or other content item. For example, a mark 250, 255, 260 may be positioned at the beginning of each chapter of a multi-chapter document, and the relative sizes of the marks 250, 255, 260 may be utilized for indicating the relative lengths of each of the chapters. In addition, text components may be displayed on each of the marks, for example, page numbers at which each of the example chapters begin, and the like.

As described above, any number of document structure attributes may be indicated by the presence and positions of one or more marks 250, 255, 260, for example, the locations of document headings, tables of contents, bibliographies, search term locations, placeholder locations, last page visited, and the like. And, as described above, different attributes may be applied to marks of different types, for example colors, size, etc. for distinguishing one notification type from another. For example, one color mark or icon may be used for indicating chapter beginnings, another color or size of mark or icon may be used for indicating locations of found search terms, and the like.

According to embodiments, the marks and/or icons represent and convey both static and dynamic information. That is, a mark or icon may be present indicating presence of a comment that was added to a document 5 days ago. If the comment is deleted, the mark or icon indicating presence of the comment will be dynamically deleted from the scrollbar. Likewise, if a first user is reviewing a document, and a second user makes a change to the document for which a mark or icon may be presented in the scrollbar, then the mark or icon will be dynamically displayed as a live notification of the change so that the first user is immediately notified. According to one embodiment, a mark or icon may be dynamically deleted if a predetermined duration of time elapses since the corresponding information was added to or annotated in the document after all users have had the predetermined duration of time to review the information. In addition, the physical attributes of the marks or icons may dynamically vary or change based on changes to the underlying information. For example, a mark or icon representing a number of comments that is displayed according to a first display size (e.g., mark 260) may dynamically change to a second display size (e.g., mark 250) if the associated number of comments is decreased or increased.

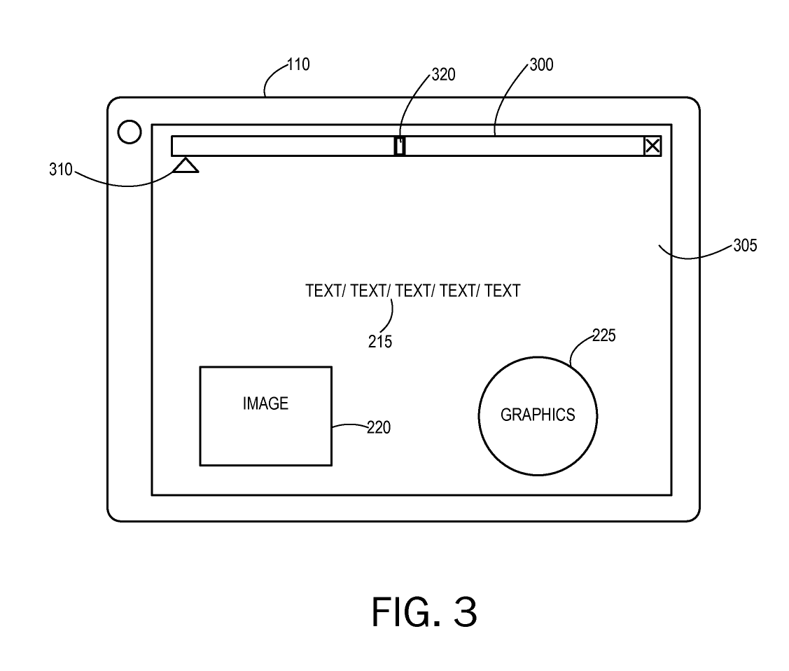

Referring now to FIG. 3, a document 305 is illustrated on a display surface of the computing device 110, and a horizontal scrollbar 300 is illustrated for allowing horizontal navigation through the content of the document 305. For example, the document 305 may include a series of slide presentations, photographs, drawings, text selections, and the like that are arranged in a horizontal relationship relative to each other requiring right-to-left or left-to-right navigation for reviewing, editing or otherwise utilizing each item contained in the document 305. A position indicator 310 is illustrated for indicating a position in the scrollbar 300 relative to a currently displayed portion, section, or other component of the document 305.

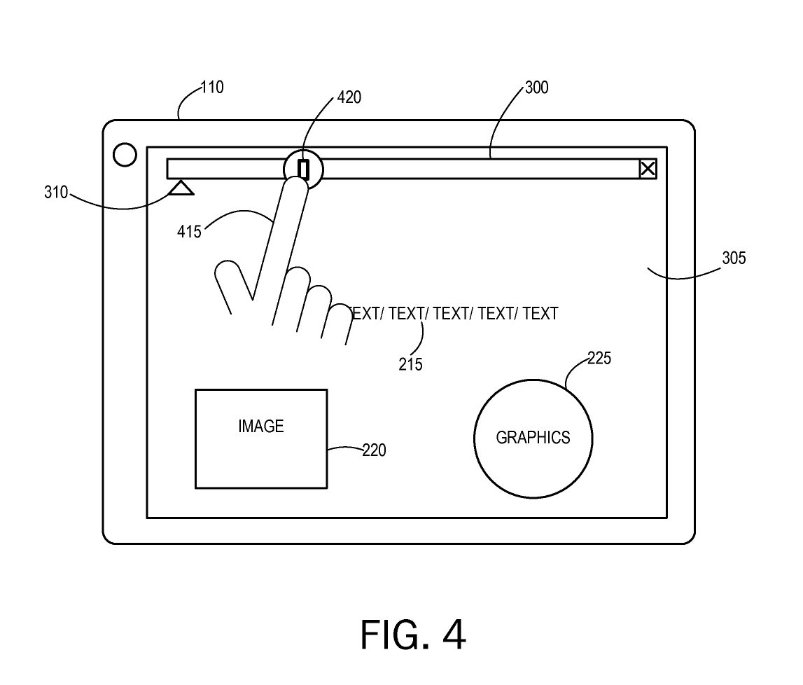

A mark or icon 320 is illustrated in the horizontal scrollbar 300 for indicating a notification of some type of information, as described above, available to the user at a position in the document 305 relative to a position in the scrollbar 300 as compared to the current position indicator 310. Thus, movement of the position indicator 310 horizontally to the right toward the mark 320 will cause a navigation of the document 305 to the left until a position in the document associated with the mark 320 is located. As should be appreciated, navigation may be performed by clicking and dragging the position indicator 310 toward the mark 320, or as illustrated in FIG. 4, automatic selection of the mark 420 may be accomplished by touch 415, gesture, voice command, clicking, or other interaction with the mark 420.

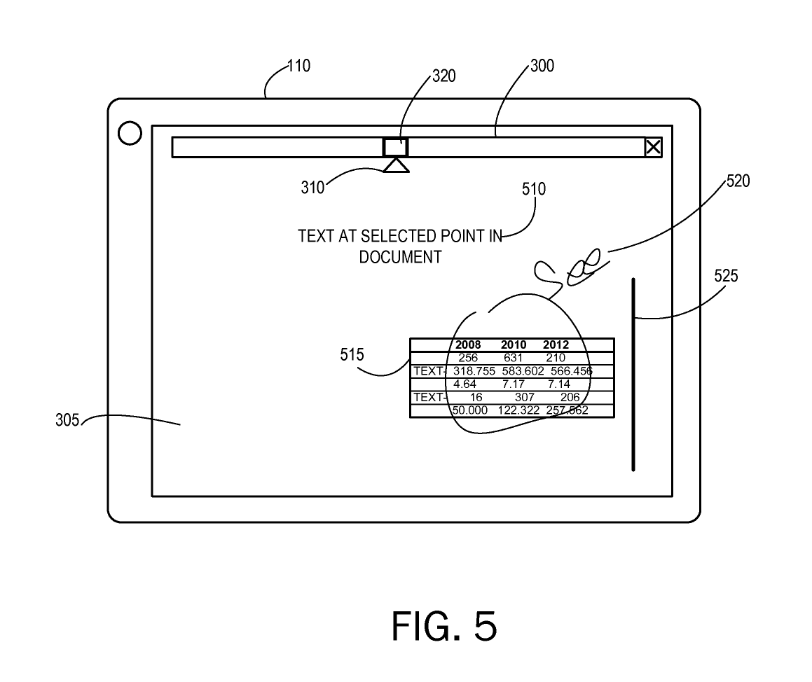

Referring to FIG. 5, in response to selection of the mark 320 (as illustrated in FIG. 4), the document is automatically navigated to the left (for example) such that the position indicator 310 is now aligned with the mark 320 to allow the user to see information in the document 305 that is associated with the notification mark 320 (presented in the scrollbar 300). As illustrated in FIG. 5, a text content 510 and a chart 515 are located in the document 305 at the position navigated to by selecting the mark/icon 320 presented in the scrollbar 300. As illustrated in FIG. 5, a handwritten notation and comment 520 has been made in the document around the chart 515, and a vertical bar 525 has been displayed for indicating a portion of the document associated with the handwritten comment. Thus, the presence of the mark or icon 320 in the scrollbar 300 indicates and notifies that some type of information is available in association with the document at a location indicated relative to the position of the mark or icon 320 as displayed in the horizontal scrollbar 300. In this example, when the user arrives at the position of the mark 320, he/she finds the handwritten notation and comment.

As described herein, according to embodiments, the mark 320 may be color-coded to indicate a comment, or the mark 320 may be in the form of a shaped icon or may include text for indicating association with a hand-written comment. In addition, if the example handwritten circle around the chart 515 is made by a first user, and the handwritten word “See” is made by a second user, the mark 320 may also provide information, for example, on hover-over or focus (via a tooltip of balloon) as to the identities and other information for the two users responsible for the handwritten notations.

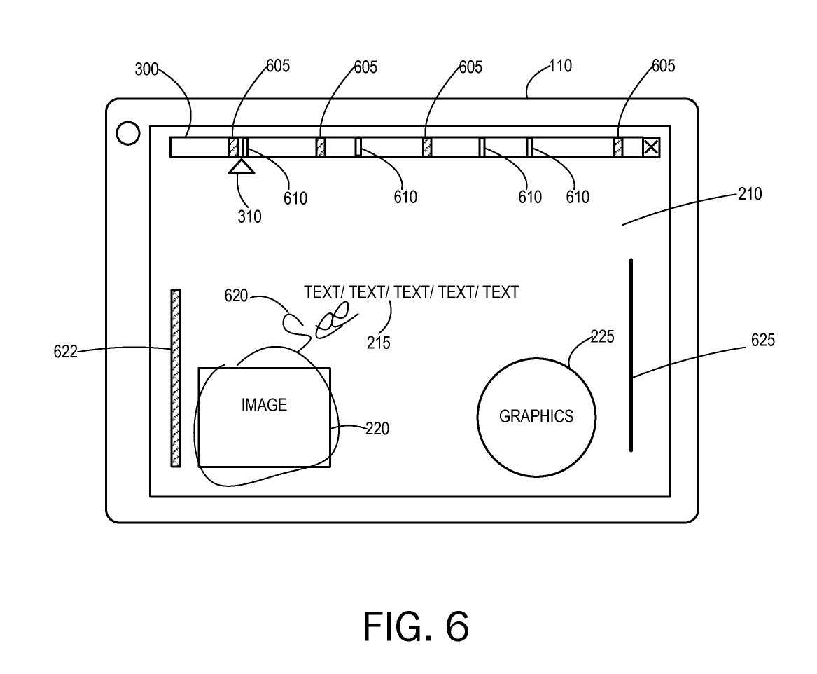

Referring now to FIG. 6, a presence of marks or icons indicating a variety of different types of notifications is illustrated in the horizontal scrollbar 300. For example, the lined marks 605 may be used for indicating the presence of comments from a particular user at locations in the document 210 relative to the positions of the marks 605 on the horizontal scrollbar 300. Similarly, the unlined marks 610 may be used for indicating the presence of one or more flags positioned in various locations of the document 210 relative to the locations in the scrollbar 300 of the associated marks 610.

For example, when the position indicator 310 is moved to the position of both the lined mark 605 and the unlined mark 610 either by moving the position indicator 310 by touch, keyboard control, mouse control, and the like, or by tapping the two marks 605, 610 by touch or other gesture, a position in the document 210 is automatically navigated to for allowing a user to review edits, annotations, or other attributes of the document associated with the two example marks 605, 610. At the position navigated to by selection of the mark 605, a comment 620 is present along with a comment indicator bar 622 for showing a position of the comment in the document 210. Likewise, because the mark 610 was presented in the scrollbar 300 at the same position as the mark 605, the user may expect to see an edit, comment, or other annotation in the document at the same location associated with the second mark 610. As illustrated in FIG. 6, a flag 625 has been placed next to a portion of text in the document 210 for alerting one or more users to pay attention to that portion of the document for some reason of importance to the user that placed the flag in that location. As should be appreciated, by selection of any of the other marks 605, 610 presented in the horizontal scrollbar 300 automatic navigation to corresponding positions in the document 210 may be accomplished for allowing a navigating user to review aspects of the document or other content item located in positions relative to the selected or navigated to scrollbar marks and/or icons 605, 610.

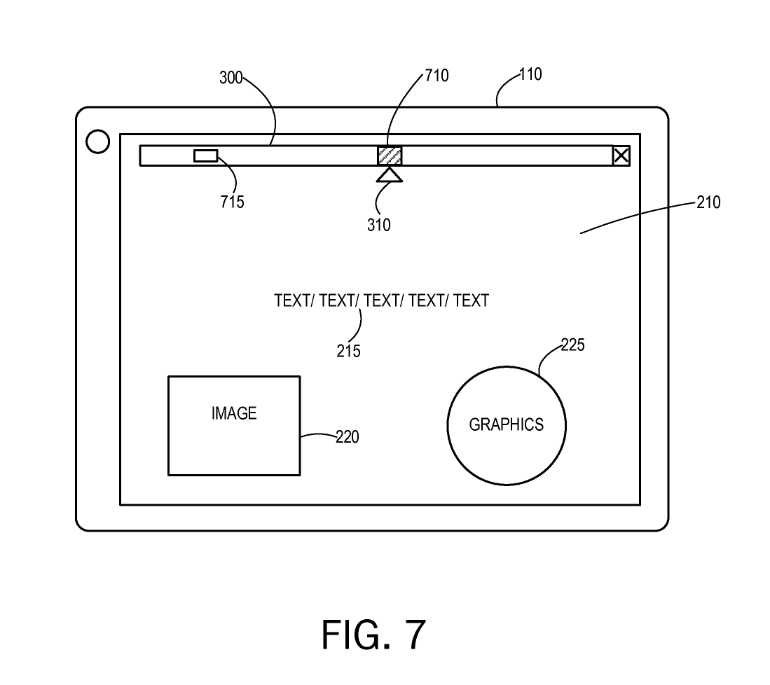

Referring now to FIG. 7, the horizontal scrollbar 300 is illustrated showing a scrollbar box or button 710 for navigating horizontally through the document by sliding the scrollbar box or button to the right or to the left along the scrollbar 300. A breadcrumb or historical navigation mark or icon 715 is illustrated in the horizontal scrollbar 300 for indicating a previous position of navigation in the document 210. For example, if the user was reviewing page 12 of a multi-page document and immediately moved the scrollbar box or button 710 to a position 310 to the right in the scrollbar 300, as illustrated in FIG. 7, the breadcrumb or historical navigation icon 715 may be displayed in the scrollbar 300 for notifying the user of the position of the immediately preceding document navigation. As should be appreciated, if a user is traversing back and forth between two pages or sections of a document located some distance from each other, placement of the breadcrumb or historical navigation indicator 715, as illustrated in FIG. 7, allows the user to have an immediate indication of the relative position in the document from which he/she just navigated to allow the user to quickly return to that position if desired.

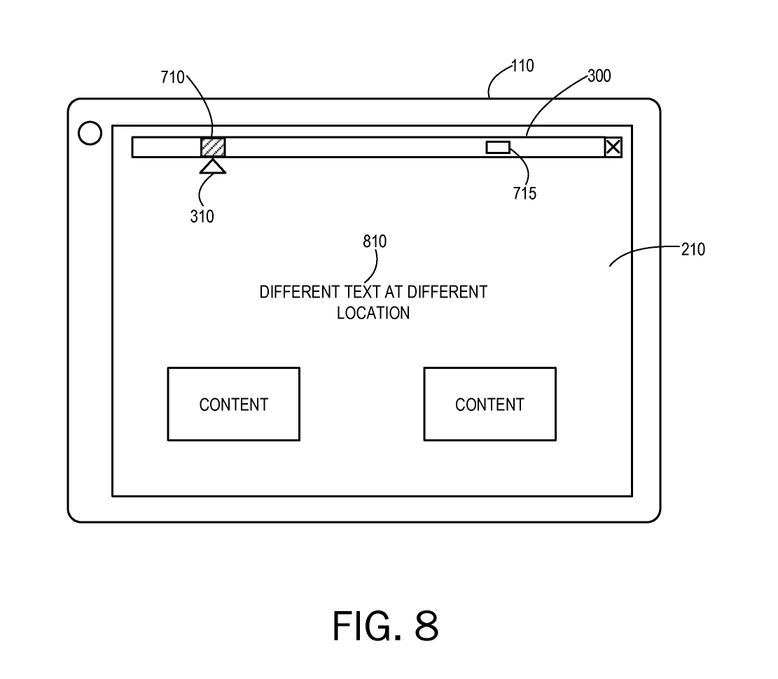

As illustrated in FIG. 8, if the user moves the scrollbar box or button 710 to the position of the breadcrumb or historical navigation icon 715, navigation back to the document position indicated by the breadcrumb or historical navigation icon 715 is accomplished. According to embodiments, the breadcrumb or historical navigation icon 715 is now be displayed in the horizontal scrollbar 300 at the last position of navigation such that the user continues to have a live notification of the immediate past navigation point in the document 210.

According to one embodiment, a “stickyness” attribute may be applied to the scrollbar 300, the scrollbar box or button 710, and/or the breadcrumb/historical navigation icon 715 such that movement of the scrollbar box or button 710 in the direction of the breadcrumb or historical navigation icon 715 results in a snapping or magnetic attraction of the scrollbar box or button 710 to the position of the breadcrumb or historical navigation icon to create a user experience of being able to quickly snap back and forth between two or more positions in a given document. Thus, as the user moves the scrollbar box or button 710 toward the position of a breadcrumb or historical navigation icon 715, the scrollbar box or button 710 eventually snaps into position over the displayed breadcrumb or historical navigation icon 715, and the displayed text or other objects of the document snaps into position along with the movement of the scrollbar box or button onto the position of the breadcrumb or historical navigation icon 715. Simultaneously, the breadcrumb or historical navigation icon 715 is then displayed in the scrollbar 300 relative to the immediate past position of document navigation, as illustrated in FIG. 8.

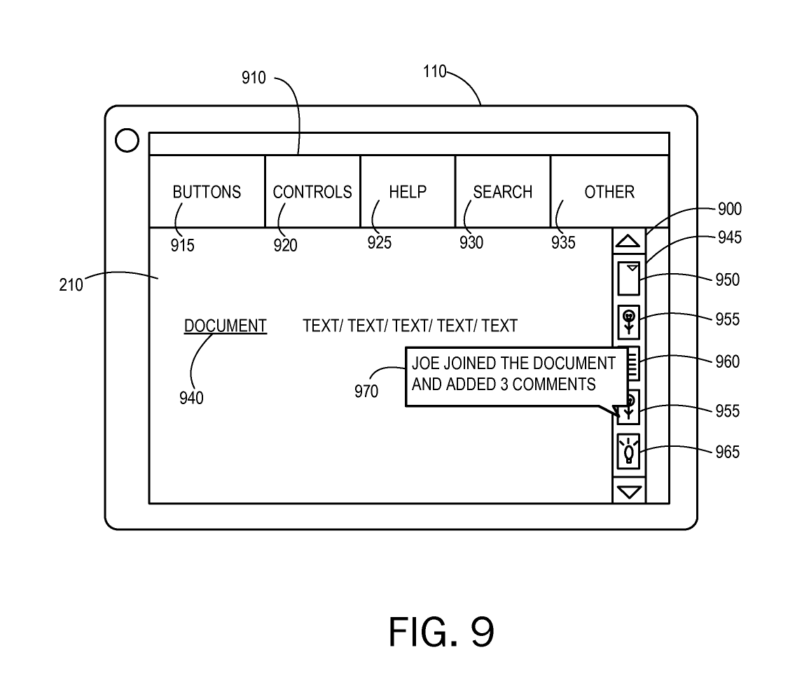

As should be appreciated, the horizontal scrollbar or scrollbar-like user interface components 300 illustrated and described above with reference to FIGS. 3-8 may be displayed in a vertical orientation for allowing similar navigation in a vertical (up or down) manner with respect to a given document or content item. Referring to FIG. 9, a vertically disposed scrollbar 900 is illustrated in association with a user interface 910 presented on a display surface of a computing device 110. A document 940 is illustrated on the display surface underneath an array of functionality buttons or controls 915, 920, 925, 930, 935 with which one or more functionalities of an associated software application may be utilized in association with the document 940.

As described above, marks or icons presented in a vertical or horizontal scrollbar may be used for providing indications of the presence of one or more information items associated with a given location in a document or other content item relative to the position of the mark or icon in the vertical or horizontal scrollbar. As illustrated in FIG. 9, the shapes, sizes and graphics applied to marks and/or icons presented in scrollbars may be used for conveying a variety of types of information to a reviewing user. For example, a comments icon 950 is illustrated for conveying that one or more comments may be located in the document 210 at a position in the document relative to the position of the comments icon 950 in the scrollbar 900. As described above, textual information, for example, a number (e.g. “3”) may be provided on the comments icon 950 for indicating other information, for example, a number of comments associated with the relevant position in the document.

An icon 955 is illustrative of a mark or icon for presenting information about document collaboration in association with the relevant location of the document to which the icon is related. For example, the collaboration icon 955 may indicate a source of information applied to a document or that one or more persons are associated with reviewing, editing, or otherwise utilizing a portion of the document located relevant to the location of the icon 955 in the scrollbar 900. According to one embodiment, a mouse-over or other focus event applied to the icon 955 may cause the presentation of a tool tip, balloon, or other user interface component 970 for providing information, for example, the identities of one or more users providing comments, the number of comments, the dates the comments were applied, and the like.

Referring to the tool tip 970, a text statement of “Joe joined the document and added three comments” is displayed in response to a mouse-over, single click, or other focus event on the icon 955 for providing the user information about what the user may find in the associated location in the document 210 without actually navigating to that location in the document. For example, if the user is in a different location in the document performing various edits to the document, and the user sees the dynamic addition of an icon 955 at a lower portion of the scrollbar 900, the user may perform a mouse-over or other focus event on the newly added icon 955 to cause the tool tip or balloon 970 to be displayed to provide information to the first user so that the user will be notified that the second user has joined the document in a collaborative work session at a different location in the document. If the first user wishes to actually navigate to that portion of the document to see changes, comments, bookmarks, flags, or other annotations to the document by the second user, the first user may quickly navigate to the position in the document being edited by the second user by selecting the icon 955, or moving the scrollbar box or button 960 to the location of the icon 955. As described above, information may also be provided as text items on the icons 955 for providing summary information, for example, a number of collaborating users associated with the document at the portion of the document corresponding to the icon.

Referring still to FIG. 9, an ideas icon 965 is illustrative of other types of icons that may be presented in a vertical or horizontal scrollbar for providing other information associated with a corresponding position in a document or other content item. For example, the ideas icon 965 may be a notification of an annotation applied to a document at the corresponding location providing one or more brainstorming ideas from one or more other users associated with the document. As should be appreciated, the example marks and icons described herein for notifying a user of the presence of potentially valuable or interesting information are for purposes of example only and are not exhaustive of the numerous additional types of marks and/or icons that may be utilized for indicating the presence of information that may be of interest to a reviewing user.

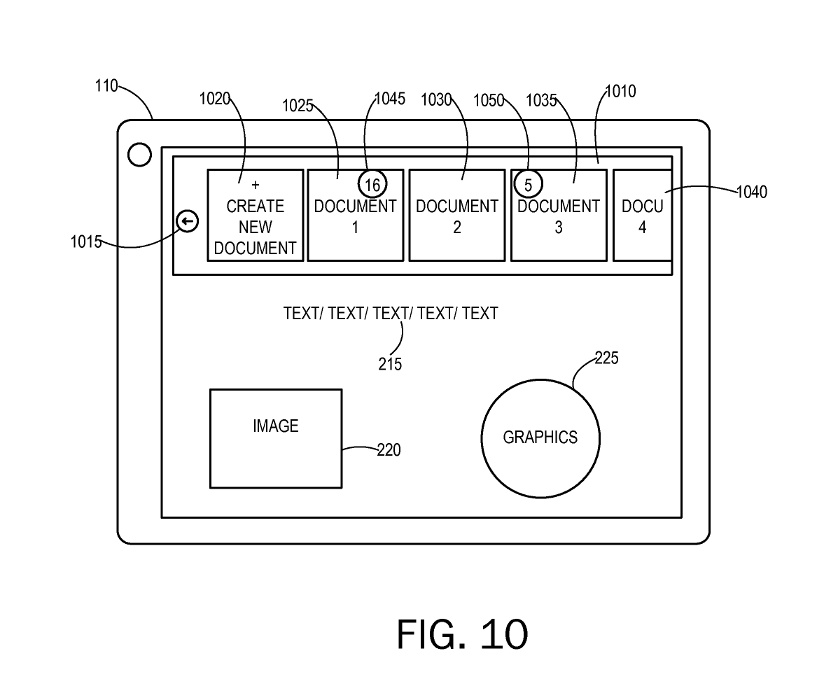

According to another embodiment, cross-document navigation and live notification may be provided. As illustrated in FIG. 10, a horizontal cross-document navigation scrollbar or pane 1010 is provided in which may be displayed application functionality, or one or more textual or graphical representations of one or more documents or content items available to a user. For example, a create new document function 1020 is illustrated for creating a new document in association with the functionality of a software application in use. A variety of document representations (e.g., thumbnail images) 1025, 1030, 1035, 1040 are illustrated in the pane 1010 corresponding to documents available to the user for editing or other utilization. For example, each of the document thumbnails illustrated in the pane 1010 may be associated with documents stored in a document repository, for example, a locally or remotely stored document folder. By populating the navigation scrollbar or scroll pane 1010, the user may scroll right-to-left or left-to-right through the representations for each of his/her documents. As should be appreciated, the scrollbar or scroll pane 1010 may be oriented in a vertical disposition and may be located at a different location on the display surface of the computing device 110, for example, at the bottom of the display surface of the computing device 110. Thus, the user may navigate through his/her available documents through any suitable navigation means, for example, by selection of a navigation icon 1015, by swiping right or left through a touch gesture on the navigation pane 1010, or through one or more keyboard or mouse entries or voice commands depending upon the operability of the device 110 for receiving various types of input.

According to embodiments, one or more marks and/or icons 1045, 1050 may be displayed on one or more of the textual 215 or graphical 220,225 representations of documents or other content items for providing live notifications to the user of one or more attributes associated with one or more of the available documents or of interesting or valuable information that may be associated with one or more of the available documents. That is, any of the marks or icons illustrated and described above for in-document navigation with reference to FIGS. 2 through 9 may likewise be applied to individual textual or graphical representations of individual documents or content items for notifying a user of one or more information types and associated information items that may be applied to one or more of the available documents. For example, the mark or icon 1045 illustrated in the document thumbnail 1025 illustrates a number “16” associated with the corresponding document. According to embodiments, the number 16 may indicate that 16 different notifications of various types may be associated with the corresponding document.

If the user selects the corresponding document, an application associated with the corresponding document, for example, a word processing application, a slide presentation application, and the like, may be used for launching an instance of the document, and then, a horizontal or vertical scrollbar as described above with reference to FIGS. 2 through 9 may be presented for the opened document to allow the user to see the nature of the 16 different notifications that have been applied to the document. For example, the 16 notifications may include 5 comments, 6 collaborating users, 3 flags, and 2 bookmarks applied to the document. As should be appreciated, use of a number for indicating a total number of notifications applied to a given document is for purposes of example only, and individual icons representing individual notification types may likewise be displayed over the graphical representations 1025, 1030, 1035, 1040 of the one or more available documents.

Having described an example operating environment and various aspects of embodiments to the present invention above with reference to FIGS. 1 through 10, FIG. 11 is a flowchart illustrating a method for enabling use of scrollbars and scrollbar-like user interface components as navigation tools and as live notification areas. The method 1100 begins at start operation 1105 and proceeds to operation 1110 where a user interface for a given software application is displayed in which may be displayed a document or other content item for edit, review or other desired utilization. At operation 1115, a desired document is displayed, and at operation 1120, an in-document navigation component, for example, a vertical or horizontal scrollbar, illustrated and described above, is displayed for allowing navigation through various portions of the displayed document.

At operation 1125, the displayed scrollbar is populated with one or more marks and/or icons for notifying a user of the presence of interesting, valuable, or other information associated with the document at various locations in the document relative to the positioning of the marks and/or icons displayed in the vertical or horizontal scrollbars. At operation 1130, information may be provided to the user via the display of the one or more marks and/or icons, as described above. For example, display sizes, display shapes, and/or textual information may be provided on or in association with the displayed marks and/or icons for providing information to a reviewing user without requiring the user to actually select the icons and navigate to the corresponding position in the document. For example, the shape of a given icon may indicate to the user that the icon is associated with one or more comments applied to the document at the corresponding document position. If the user is not interested in reading the comments at the present time, the user may avoid navigating to that portion of the document until a later time.

At operation 1135, a selection of one or more of the marks or icons is received. At operation 1140, if a tool tip, balloon, or other user interface component is operative for displaying information about the selected or focused-on mark or icon, then such a user interface component may be displayed, as illustrated above with reference to FIG. 9, and information about the notification associated with the mark or icon may be provided.

At operation 1145, an automatic navigation to a portion of the document associated with the selected mark or icon may be performed for displaying that portion of the document for allowing the user to review content and/or one or more annotations or other notification types associated with the selected mark or icon. That is, once the user navigates to a position in the document associated with the selected mark or icon, the user may see information for which the notification is provided, as illustrated in FIGS. 5 and 6.

At operation 1150, a breadcrumb or historical navigation icon may be displayed in the horizontal or vertical scrollbar at the immediate past navigation position for allowing the user to readily see the location in the document from which he/she just navigated, as illustrated in FIG. 7. As illustrated in FIG. 8, the breadcrumb or historical navigation icon may be utilized for allowing the user to snap back to the immediate past navigation point so that the user may traverse back and forth between two or more positions in the corresponding document, as desired.

At operation 1155, if the user desires to navigate through a number of different available documents, the cross-navigation scrollbar or scroll pane, illustrated in FIG. 10, may be provided, and at operation 1160, one or more marks and/or icons may be provided on or in association with graphical representations of the available documents for notifying the user of information and/or annotations associated with one or more of the available documents. At operation 1165, cross-document navigation is enabled, as described above with reference to FIG. 10. The method ends at operation 1195.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

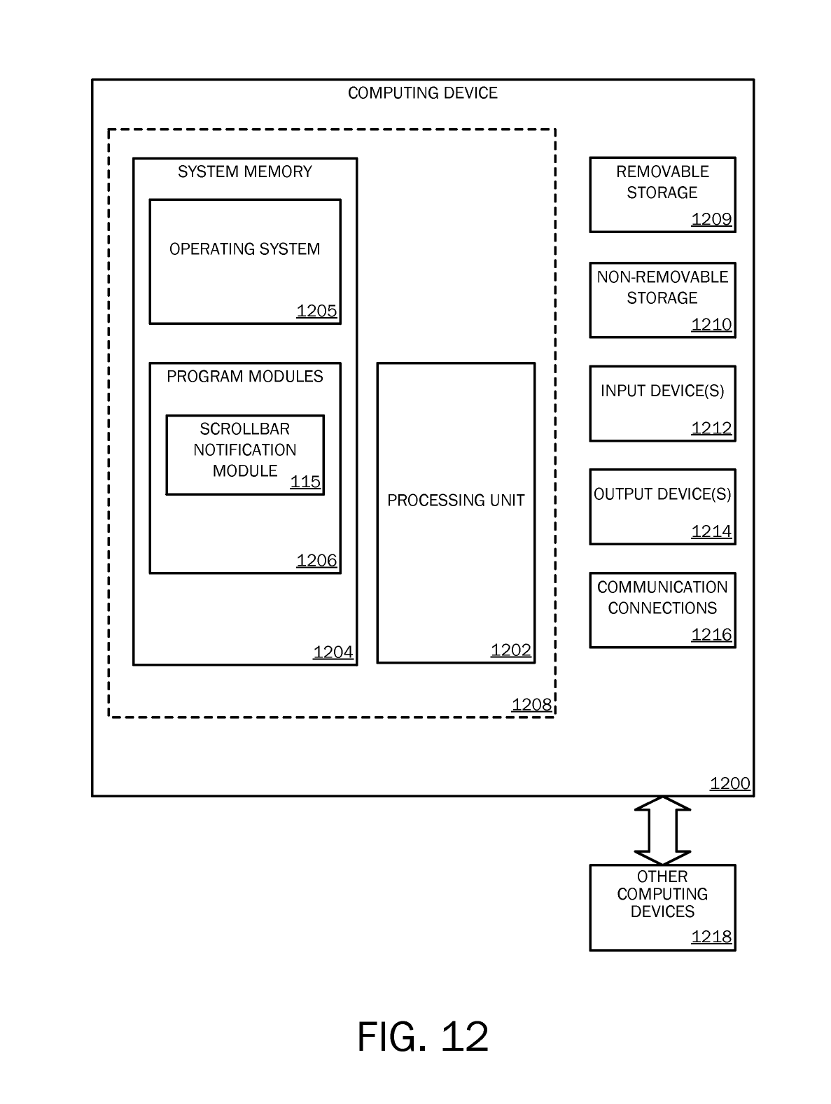

FIGS. 12-14 and the associated descriptions provide a discussion of a variety of operating environments in which embodiments of the invention may be practiced. However, the devices and systems illustrated and discussed with respect to FIGS. 12-14 are for purposes of example and illustration and are not limiting of a vast number of computing device configurations that may be utilized for practicing embodiments of the invention, described herein.

FIG. 12 is a block diagram illustrating physical components (i.e., hardware) of a computing device 1200 with which embodiments of the invention may be practiced. The computing device components described below may be suitable for the computing devices 105, 110 described above. In a basic configuration, the computing device 1200 may include at least one processing unit 1202 and a system memory 1204. Depending on the configuration and type of computing device, the system memory 1204 may comprise, but is not limited to, volatile storage (e.g., random access memory), non-volatile storage (e.g., read-only memory), flash memory, or any combination of such memories. The system memory 1204 may include an operating system 1205 and one or more program modules 1206 suitable for running a variety of applications. The operating system 1205, for example, may be suitable for controlling the operation of the computing device 1200. Furthermore, embodiments of the invention may be practiced in conjunction with a graphics library, other operating systems, or any other application program and is not limited to any particular application or system. This basic configuration is illustrated in FIG. 12 by those components within a dashed line 1208. The computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by a removable storage device 1209 and a non-removable storage device 1210.

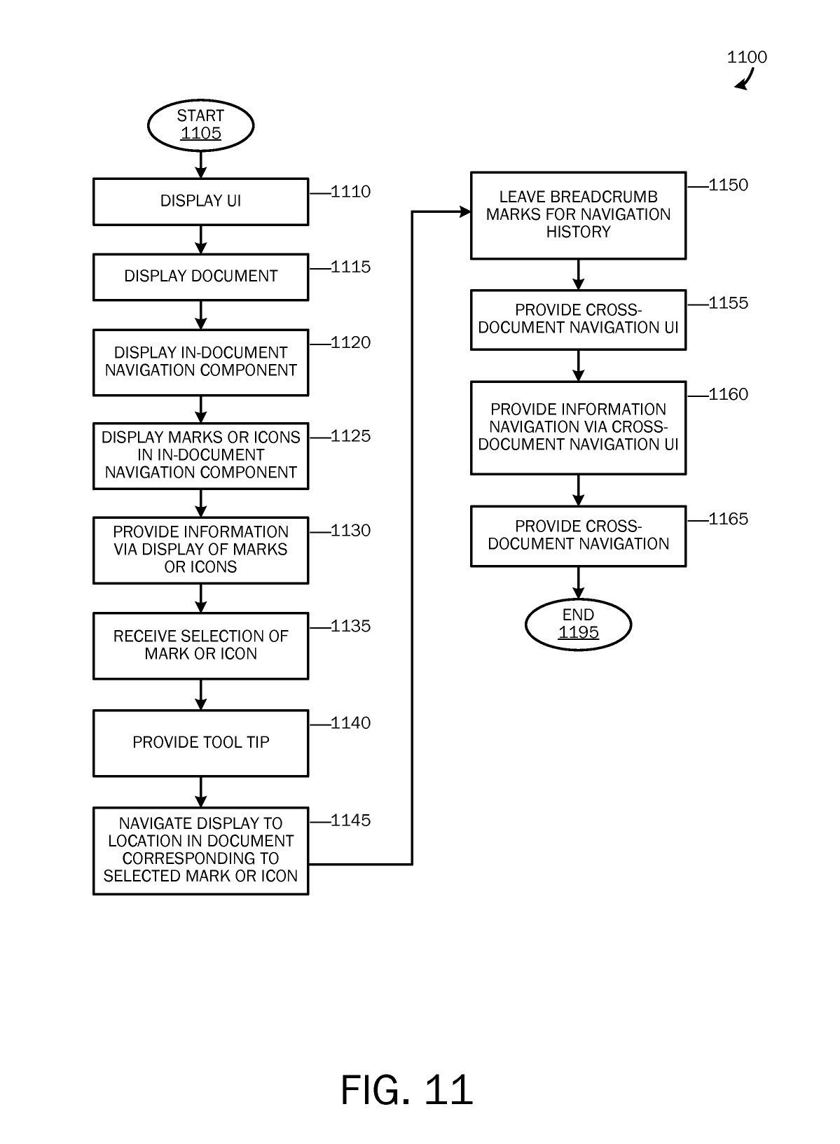

As stated above, a number of program modules and data files may be stored in the system memory 1204. While executing on the processing unit 1202, the program modules 1206 may perform processes including, but not limited to, one or more of the stages of the method 1100 illustrated in FIG. 11. Other program modules that may be used in accordance with embodiments of the present invention may include a variety of software applications, such as, notes applications, Internet browser applications, electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to use of web page content may be operated via application-specific logic integrated with other components of the computing device 1200 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1200 may also have one or more input device(s) 1212 such as a keyboard, a mouse, a pen, a sound input device, a touch input device, etc. The output device(s) 1214 such as a display, speakers, a printer, etc. may also be included. The aforementioned devices are examples and others may be used. The computing device 1200 may include one or more communication connections 1216 allowing communications with other computing devices 1218. Examples of suitable communication connections 1216 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1204, the removable storage device 1209, and the non-removable storage device 1210 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1200. Any such computer storage media may be part of the computing device 1200.

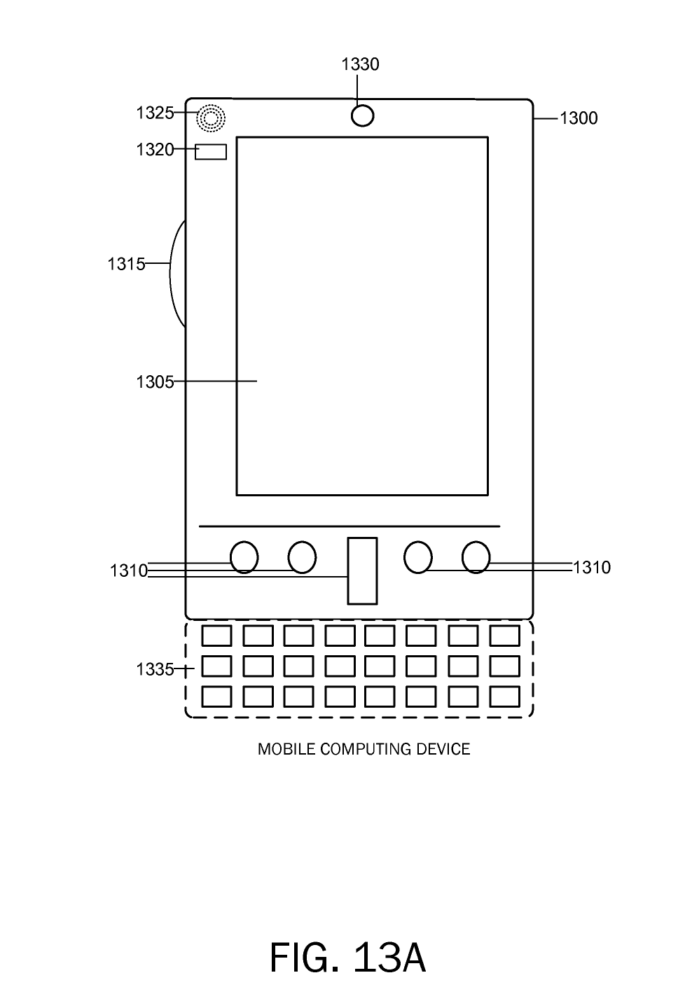

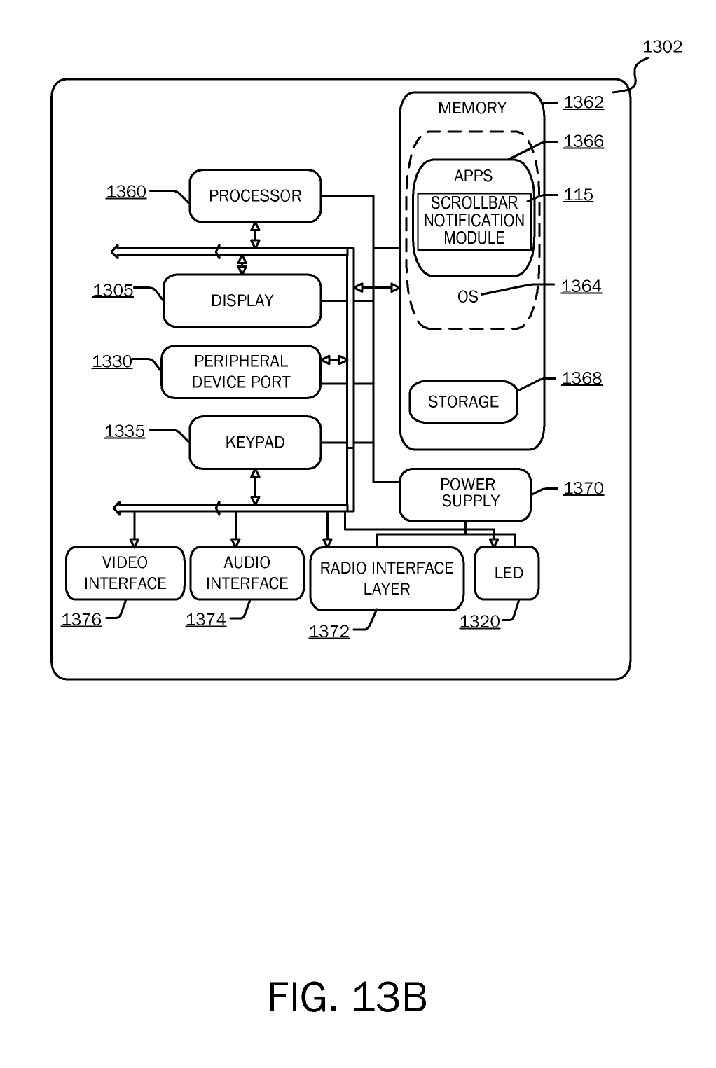

FIGS. 13A and 13B illustrate a mobile computing device 1300, for example, a mobile telephone, a smart phone, a tablet-style personal computer 110, a laptop computer, and the like, with which embodiments of the invention may be practiced. With reference to FIG. 13A, one embodiment of a mobile computing device 1300 for implementing the embodiments is illustrated. In a basic configuration, the mobile computing device 1300 is a handheld computer having both input elements and output elements. The mobile computing device 1300 typically includes a display 1305 and one or more input buttons 1310 that allow the user to enter information into the mobile computing device 1300. The display 1305 of the mobile computing device 1300 may also function as an input device (e.g., a touch screen display). If included, an optional side input element 1315 allows further user input. The side input element 1315 may be a rotary switch, a button, or any other type of manual input element. In alternative embodiments, mobile computing device 1300 may incorporate more or less input elements. For example, the display 1305 may not be a touch screen in some embodiments. In yet another alternative embodiment, the mobile computing device 1300 is a portable phone system, such as a cellular phone. The mobile computing device 1300 may also include an optional keypad 1335. Optional keypad 1335 may be a physical keypad or a “soft” keypad generated on the touch screen display. In various embodiments, the output elements include the display 1305 for showing a graphical user interface (GUI), a visual indicator 1320 (e.g., a light emitting diode), and/or an audio transducer 1325 (e.g., a speaker). In some embodiments, the mobile computing device 1300 incorporates a vibration transducer for providing the user with tactile feedback. In yet another embodiment, the mobile computing device 1300 incorporates input and/or output ports, such as an audio input (e.g., a microphone jack), an audio output (e.g., a headphone jack), and a video output (e.g., a HDMI port) for sending signals to or receiving signals from an external device.

FIG. 13B is a block diagram illustrating the architecture of one embodiment of a mobile computing device. That is, the mobile computing device 1300 can incorporate a system (i.e., an architecture) 1302 to implement some embodiments. In one embodiment, the system 1302 is implemented as a “smart phone” capable of running one or more applications (e.g., browser, e-mail, calendaring, contact managers, messaging clients, games, and media clients/players). In some embodiments, the system 1302 is integrated as a computing device, such as an integrated personal digital assistant (PDA) and wireless phone.

One or more application programs may be loaded into the memory 1362 and run on or in association with the operating system 1364. Examples of the application programs include phone dialer applications, e-mail applications, personal information management (PIM) applications, word processing applications, spreadsheet applications, Internet browser applications, notes applications, messaging applications, and so forth. The system 1302 also includes a non-volatile storage area 1368 within the memory 1362. The non-volatile storage area 1368 may be used to store persistent information that should not be lost if the system 1302 is powered down. The application programs may use and store information in the non-volatile storage area 1368, such as e-mail or other messages used by an e-mail application, and the like. A synchronization application (not shown) also resides on the system 1302 and is programmed to interact with a corresponding synchronization application resident on a host computer to keep the information stored in the non-volatile storage area 1368 synchronized with corresponding information stored at the host computer. As should be appreciated, other applications may be loaded into the memory 1362 and run on the mobile computing device 1300.

The system 1302 has a power supply 1370, which may be implemented as one or more batteries. The power supply 1370 might further include an external power source, such as an AC adapter or a powered docking cradle that supplements or recharges the batteries.

The system 1302 may also include a radio 1372 that performs the function of transmitting and receiving radio frequency communications. The radio 1372 facilitates wireless connectivity between the system 1302 and the “outside world,” via a communications carrier or service provider. Transmissions to and from the radio 1372 are conducted under control of the operating system 1364. In other words, communications received by the radio 1372 may be disseminated to the application programs 120 via the operating system 1364, and vice versa.

The visual indicator 1320 may be used to provide visual notifications and/or an audio interface 1374 may be used for producing audible notifications via the audio transducer 1325. In the illustrated embodiment, the visual indicator 1320 is a light emitting diode (LED) and the audio transducer 1325 is a speaker. These devices may be directly coupled to the power supply 1370 so that when activated, they remain on for a duration dictated by the notification mechanism even though the processor 1360 and other components might shut down for conserving battery power. The LED may be programmed to remain on indefinitely until the user takes action to indicate the powered-on status of the device. The audio interface 1374 is used to provide audible signals to and receive audible signals from the user. For example, in addition to being coupled to the audio transducer 1325, the audio interface 1374 may also be coupled to a microphone to receive audible input, such as to facilitate a telephone conversation. In accordance with embodiments of the present invention, the microphone may also serve as an audio sensor to facilitate control of notifications, as will be described below. The system 1302 may further include a video interface 1376 that enables an operation of an on-board camera 1330 to record still images, video stream, and the like.

A mobile computing device 1300 implementing the system 1302 may have additional features or functionality. For example, the mobile computing device 1300 may also include additional data storage devices (removable and/or non-removable) such as, magnetic disks, optical disks, or tape. Such additional storage is illustrated in FIG. 13B by the non-volatile storage area 1368.

Data/information generated or captured by the mobile computing device 1300 and stored via the system 1302 may be stored locally on the mobile computing device 1300, as described above, or the data may be stored on any number of storage media that may be accessed by the device via the radio 1372 or via a wired connection between the mobile computing device 1300 and a separate computing device associated with the mobile computing device 1300, for example, a server computer in a distributed computing network, such as the Internet. As should be appreciated such data/information may be accessed via the mobile computing device 1300 via the radio 1372 or via a distributed computing network. Similarly, such data/information may be readily transferred between computing devices for storage and use according to well-known data/information transfer and storage means, including electronic mail and collaborative data/information sharing systems.

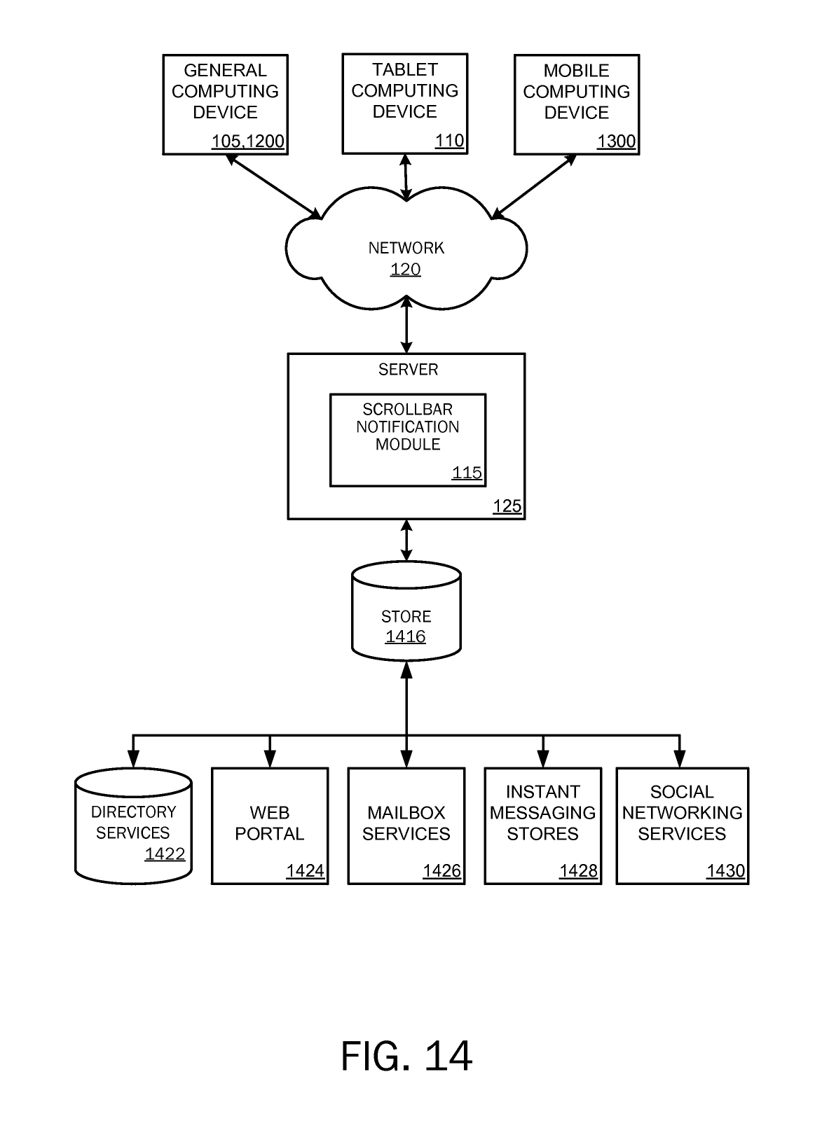

FIG. 14 illustrates one embodiment of the architecture of a system for providing scrollbar live notifications, as described above. Content developed, interacted with, or edited in association with embodiments of the invention may be stored in different communication channels or other storage types. For example, various documents and stored content items (scrollbar notifications) may be stored using a directory service 1422, a web portal 1424, a mailbox service 1426, an instant messaging store 1428, or a social networking site 1430. The scrollbar notification functionality described herein may use any of these types of systems or the like for enabling data utilization, as described herein. A server 125 may provide functionality of the scrollbar notification module 115 to clients. As one example, the server 125 may be a web server providing the web content and associated functionality over the web. The server 125 may provide the functionality of the scrollbar notification module 115 over the web to clients through a network 120. By way of example, the client computing device may be implemented and embodied in a personal computer 105, 1200, a tablet computing device 110 and/or a mobile computing device 1300 (e.g., a smart phone), or other computing device. Any of these embodiments of the client computing device 1200, 105, 110,1300 may obtain content from the store 1416.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A computer implemented method of using scrollbars as information notification areas; comprising:
displaying an electronic document in a computer-enabled user interface;
displaying a scrollbar for allowing navigation of the electronic document; and
displaying in the scrollbar a notification mark for notifying a user that information is present in the electronic document at a position in the electronic document relative to a position in the scrollbar at which the notification mark is displayed, wherein one or more display characteristics of the notification mark conveying information about the information that is present in the electronic document.

2. The method of claim 1, wherein conveying information about the information that is present in the electronic document includes conveying one or more of a type of the information that is present in the electronic document; a quantity of items comprising the information that is present in the electronic document; a source of the information that is present in the electronic document; and a summary of a plurality of items comprising the information that is present in the electronic document.

3. The method of claim 2, wherein conveying a type of the information that is present in the electronic document includes conveying that the information that is present in the electronic document is one or more of a user-created item; a document structure element; a document collaboration information; and an information summary.

4. The method of claim 1, further comprising:
receiving a selection of the notification mark;
navigating to and displaying a portion of the electronic document located at the position in the electronic document relative to the position in the scrollbar at which the notification mark is displayed;
providing at the navigated to portion of the electronic document the information that is present in the electronic document at the position in the electronic document relative to the position in the scrollbar at which the notification mark is displayed.

5. The method of claim 1, further comprising varying the one or more display characteristics of the notification mark for conveying different amounts or types of information that is present in the electronic document.

6. The method of claim 5, wherein varying the one or more display characteristics of the notification mark for conveying different amounts or types of information that is present in the electronic document includes varying the one or more display characteristics according to one or more of size, color, shape, design, textual content, graphical presentation and animation.

7. The method of claim 1, further comprising dynamically varying the one or more display characteristics of the notification mark if the information that is present in the electronic document changes.

8. The method of claim 7, wherein dynamically varying the one or more display characteristics of the notification mark if the information that is present in the electronic document changes includes deleting a display of the notification mark from scrollbar if the information that is present in the electronic document is deleted.

9. The method of claim 8, wherein dynamically varying the one or more display characteristics of the notification mark if the information that is present in the electronic document changes includes deleting a display of the notification mark from scrollbar after an elapse of a predetermined duration of time.

10. The method of claim 1, further comprising dynamically displaying in the scrollbar a second notification mark for notifying a user that a second information is present in the electronic document at a position in the electronic document relative to a position in the scrollbar at which the second notification mark is displayed.

11. The method of claim 1, further comprising:
receiving a focus on the notification mark; and
displaying a tooltip component for providing the information about the information that is present in the electronic document.

12. The method of claim 1, wherein:
displaying in the scrollbar a notification mark for notifying a user that information is present in the electronic document at a position in the electronic document relative to a position in the scrollbar at which the notification mark is displayed includes displaying in the scrollbar a notification mark for notifying the user of a previous navigation position in the electronic document.

13. The method of claim 12, further comprising:
moving a scrollbar navigation button in scrollbar toward the notification mark for notifying the user of a previous navigation position in the electronic document;
snapping the scrollbar navigation button onto the notification mark for notifying the user of a previous navigation position in the electronic document; and
automatically navigating to and displaying a portion of the electronic document located at the previous navigation position in the electronic document.

14. A computer implemented method of cross-document navigation and document information provision; comprising:
displaying in an electronic user interface a navigation pane for allowing scrolling navigation of graphical representations of a plurality of electronic documents; and
displaying in one or more of the graphical representations information about one or more attributes of one or more electronic documents corresponding to the one or more graphical representations.

15. The method of claim 14, wherein displaying in one or more of the graphical representations information about one or more attributes of one or more electronic documents corresponding to the one or more graphical representations includes displaying in the one or more graphical representations an icon that represents the presence of the information about the one or more attributes of one or more electronic documents.

16. The method of claim 15, further comprising conveying via one or more display characteristics of the icon that the one or more attributes of the one or more documents include one or more of a user-created item; a document structure element; a document collaboration information; and an information summary.

17. The method of claim 14, further comprising:
receiving a selection of a graphical representation one of the plurality of electronic documents;
displaying an electronic document corresponding to the selected graphical representation;
displaying a scrollbar for allowing navigation of the electronic document; and
displaying in the scrollbar a notification mark corresponding to each of one or more attributes of the electronic document for which information is displayed in the selected graphical representation.

18. The method of claim 17, further comprising notifying a user via the notification mark that information is present in the electronic document at a position in the electronic document relative to a position in the scrollbar at which the notification mark is displayed, wherein one or more display characteristics of the notification mark conveying information about the information that is present in the electronic document.

19. A system for using scrollbars as information notification areas; comprising:
one or more processors; and
a memory coupled to the one or more processors, the one or more processors operable to:
display an electronic document in a computer-enabled user interface;
display a scrollbar for allowing navigation of the electronic document; and
display in the scrollbar a notification mark for notifying a user that information is present in the electronic document at a position in the electronic document relative to a position in the scrollbar at which the notification mark is displayed, wherein one or more display characteristics of the notification mark conveying information about the information that is present in the electronic document.

20. The system of claim 19, being further operable to varying the one or more display characteristics of the notification mark for conveying different amounts or types of information that is present in the electronic document as the information that is present in the electronic document changes.
